(19) United States
(12) Patent Application Publication
(10) Pub. No.: US 2006/0127762 A1
(43) Pub. Date: Jun. 15, 2006

(54) Impact resistant electrochemical cell with tapered electrode and crumple zone

(76) Inventors: Russell E. Gyenes, Lawrenceville, GA (US); Micheal M. Austin, Lilburn, GA (US)

Correspondence Address: MOTOROLA, INC.;LAW DEPARTMENT, 600 NORTH U.S. HIGHWAY 45, AS437, LIBERTYVILLE, IL, 60048, US

(21) Appl. No.: 11/012,648

(22) Filed: Dec. 15, 2004

(51) Int. Cl. H01M 4/02; H01M 6/10

(52) U.S. Cl. 429/209; 429/94

(57) ABSTRACT

This invention includes a tapered electrode assembly for providing a crumple zone in a rechargeable cell. The taper, which may be curvilinear, angular or piecewise linear, allows a void to exist between the corner of the metal can and the electrode assembly. This “crumple zone” prevents any external damage to the can from damaging the internal electrode assembly. The invention facilitates passage of common OEM drop testing without compromising cell performance or energy storage capacity. The invention increases the reliability of the cell by allowing the cell to resist external impacts.

### BACKGROUND

1. Technical Field

This invention relates generally to rechargeable electrochemical battery cells, and more particularly to impact resistant designs for such cells.

2. Background Art

Portable, battery-operated, electronic devices seem to be everywhere. From handheld games, to compact disc players, to radios, to personal data assistants (PDAs), to phones, to pagers, it is becoming rare to encounter a person who does not carry at least one portable electronic device with them at all times. People carry the devices for entertainment, for organizational purposes, and for staying connected with others. A common characteristic shared by each of these devices is that they all rely on batteries for portability.

Batteries are manufactured by taking two electrically opposite electrodes and stacking them together, with each electrode being physically separate from the other. A common way to manufacture the electrochemical cells used in the batteries is known as the “jellyroll” technique, where the inner parts of the cell are rolled up and placed inside an aluminum can, thereby resembling an old-fashioned jellyroll cake. Aluminum is the preferred metal for the can due to its light weight and favorable thermal properties. To understand the jellyroll technique, consider the following example:

Cells are made of a positive electrode (cathode), a negative electrode (anode). A separator prevents these two electrodes from touching, while allowing electrons to pass through. Referring now to FIG. 1, illustrated therein is a cross-sectional side view of a typical electrode layer assembly. The electrode 10 includes a separator 12 having a top and bottom 14 and 16. Disposed on the top 14 of the separator 12 is a first layer 18 of an electrochemically active material. For example, in a nickel metal hydride battery, layer 18 may be a layer of a metal hydride charge storage material as is known in the art. Alternatively, layer 18 may be a lithium or a lithium intercalation material as is commonly employed in lithium batteries.

Disposed atop layer 18, is a current collecting layer 20. The current collecting layer may be fabricated of any of a number of metals known in the art. Examples of such metals include, for example, nickel, copper, stainless steel, silver, and titanium. Disposed atop the current collection layer 20 is a second layer 22 of electrochemically active material.

Referring now to FIGS. 2 and 3, illustrated therein is stack of electrodes like that in FIG. 1 assembled in the jellyroll configuration so as to make a rechargeable cell. In FIGS. 2 and 3, two electrodes 40 and 60 are provided as described above. Electrode 40 is fabricated with two layers of, for example, negative/active electrochemical material while electrode 60 is fabricated with two layers of positive electrode material. Each electrode 40,60 is provided with a current collecting region 20. The current collecting region 20 is disposed on the current collector, and allows for electrical communication between the electrode itself and a terminal on the outside of the cell can into which the electrode stack of FIG. 2 may be inserted. While the current collecting region 20 is disposed on the top and bottom of the jellyroll in this exemplary embodiment, note that they may equally be located at the leading and trailing edges of the jellyroll as well.

The electrodes 40 and 60 are arranged in stacked relationship with the current collecting regions 20 disposed on opposite edges of the stack. Thereafter, the stack is rolled into a roll 70 for a subsequent insertion into an electrochemical cell can. The cans are generally oval, rectangular or circular in cross section with a single opening and a lid. This is similar to the common trashcan.

Referring now to FIG. 3, illustrated therein is a cross-sectional cut-away view of the stacked configuration shown in FIG. 2. Here, electrodes 40 and 60 can be seen in stacked orientation. Electrode 40 comprises substrate 42 first layer of negative active material 44, current collecting layer 46, and second layer of active material 48. Disposed immediately atop layer 48 is the separator 62 of electrode 60. Thereafter the first layer of active material 64 is disposed atop the separator 62 with current collecting layer 66 disposed there over and second layer of active material 68 disposed atop the current collecting layer.

As the configuration is rolled into roll 70, the outer membrane layer is rolled into contact with the membrane substrate layer 42 of electrode 40 is rolled into contact with the second layer of active material 68 of electrode 60. In this way, the membrane substrate layers act as a separator to electrically isolate the positive and negative electrodes from one another. Moreover, as the membranes are porous, they may be filled with a liquid electrolyte such as is known in the art. Accordingly, the membrane allows for deposition of ultra-thin electrode layers, and current collecting layers, while providing the function of both electrolyte reservoir and separator. The result is ultra-thin electrodes having extremely high capacity.

Once the jellyroll is complete, it is inserted into a metal can 122 as shown in FIG. 4. The metal can 122 includes a first metal connector 24 that may serve as the cathode and a second metal connector 26 capable of serving as the anode. Looking to the jellyroll, the various layers can be seen: separator 34, first electrode 34, and second electrode 36. Depending upon the construction, an electron or current collector or grid 38 may be added to the device if desired. The current collector 38 is typically formed from a metal such as cobalt, copper, gold, iron, manganese, nickel, platinum, silver, tantalum, titanium, or zinc.

Traditionally, such metal-can type batteries were inserted into plastic battery housings that included circuitry like protection circuits, charging circuits, fuel gauging circuits and the like. The plastic battery housings were then used with electronic host devices. However, as electronic devices have gotten smaller and smaller, manufacturers have begun putting the associated battery circuitry in the host device. Thus, they use just the metal-can battery, without a protective plastic housing, in their devices.

This creates a problem in that, as stated above, the metal cans are generally made from soft metals like aluminum. Thus, when the metal-can battery is dropped, the can may dent, bend and deform. Recall from above that it is important in battery construction that the cathode and anode be kept apart by the separator or membrane layer. If the metal can bends or dents, this may cause the cathode and anode to touch either the inside of the can or each other, thereby creating a short circuit condition in the can. Short circuit conditions can lead to high currents that generate high temperatures and seriously compromise reliability of the battery.

There is thus a need for an improved metal-can battery assembly that prevents short circuit conditions caused by impact related deformations in the metal can.

### BRIEF DESCRIPTION OF THE DRAWINGS

FIG. 1 is a cross-sectional side view of a typical prior art electrode layer assembly.

FIG. 2 is a prior art stack of electrodes assembled in the jellyroll configuration so as to make a rechargeable cell.

FIG. 3 is a cross-sectional cut-away view of the stacked configuration shown in FIG. 2.

FIG. 4 is cut away, cross sectional view of a prior art jellyroll inserted into a metal can.

FIG. 5 is a cross sectional view of a prior art metal-can battery that has been repeatedly dropped on a hard surface as is typical in OEM quality and qualification practice.

FIG. 6 is a perspective view of one preferred embodiment of an electrode assembly in accordance with the invention.

FIGS. 7A-C are comparisons of cross-sectional views various electrodes that may be used in accordance with the invention.

FIG. 8 illustrates an electrode in accordance with the invention being rolled into a cinnamon bun shape.

FIG. 9 illustrates a cell assembly in accordance with the invention.

FIG. 10 illustrates a comparison of the prior art cell and a cell in accordance with the invention.

FIG. 11 illustrates an alternate embodiment of an electrode assembly in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

Referring now to FIG. 5, illustrated therein is a cross sectional view of a prior art metal-can battery that has been repeatedly dropped on a hard surface as is typical in OEM quality and qualification practice. For example, a typical qualification test may require the battery withstand 30 five-foot drops to a concrete surface. Testing was done on common lithium-ion metal-can cells in the lab. Test results showed that on average 7 batteries in 500 failed this test, with an average of 4 failing within the first 18 drops. Nothing would be more frustrating for a consumer than to pay $200 for a new personal organizer only to drop it a couple of times and have it stop working! As shown in FIG. 5, the failure is caused by deformation 502 of the metal can 500 causing damage 503 to the inner jellyroll 501. As stated above, this damage 503 can cause short circuits within the cell.

The present invention prevents such a deformed jellyroll situation by employing an electrode assembly that provides a “crumple zone” into which a can or housing may deform without contacting the electrode assembly itself. The electrode assembly of the present invention has a central length that is longer than an exterior length. In other words, at least one end of the electrode assembly is tapered from the center to the exterior. When the electrode assembly is inserted into a can, the tapered profile shape leaves a void or air gap between the electrode assembly and the can. This void provides the crumple zone that allows the cell to keep functioning, even after it has been dropped.

Commonly assigned U.S. Pat. No. 6,574,111, entitled “Impact Resistant Rechargeable Battery Cell with Crumple Zone” teaches the utilization of the spacer to create a crumple zone. While the '111 patent works well in practice, the present invention eliminates the need for a spacer, thereby both saving cost and increasing the total amount of energy that may be stored within the cell (by increasing the amount of active material within the cell).

The invention may be manufactured in several different ways. In one embodiment, the electrode assembly is wound, as in the traditional jellyroll process. The shape of the unwound electrode is such that when the assembly is wound, the height of the electrode becomes shorter. Expressed differently, the jellyroll, when viewed from a cross-section, has a radiused or tapered end.

Turning now to FIG. 6, illustrated therein is one example of an electrode assembly 601 in accordance with the invention. The embodiment of FIG. 6 is formed by wrapping the electrode into a jellyroll structure. As will be seen in the discussion of FIG. 11, the invention may also be formed by stacking layers of electrode material atop each other.

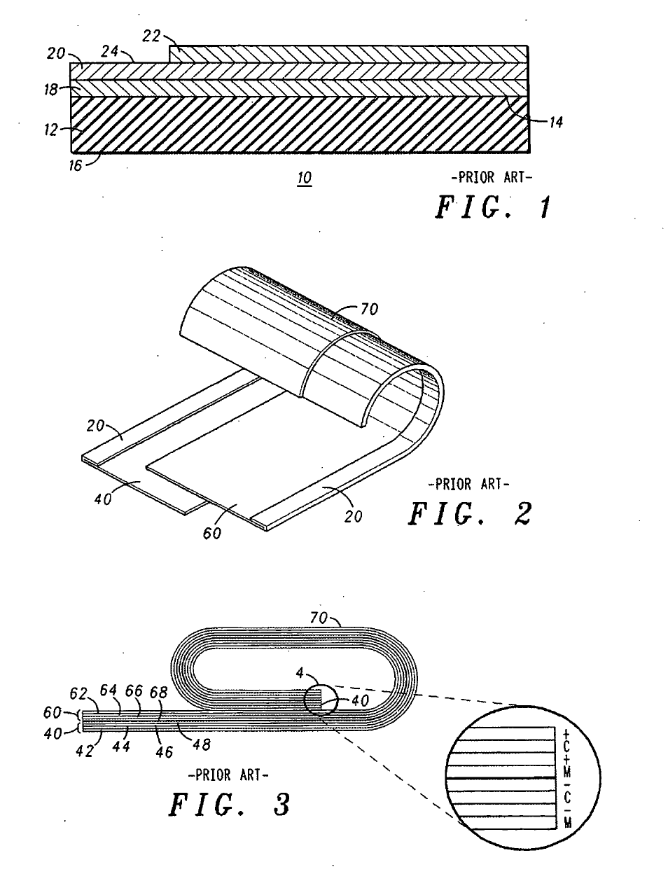

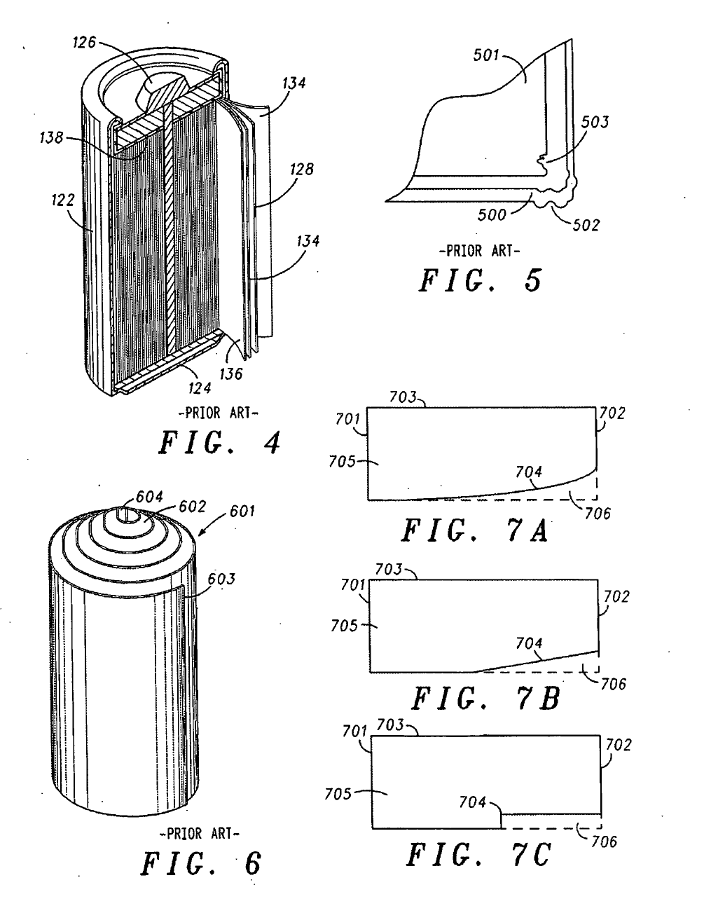

The electrode assembly 601 is created by rolling a shaped, elongated electrode. Such an electrode layer may include the constituent layers of material as described in FIG. 1. The elongated electrode layer has a first end 602 and a second end 603. The layer is shaped so that the first end 602 is wider than the second end 603. As such, when the layer is rolled starting with the first end 602, the resulting electrode assembly 601 will be taller in the center (i.e. the central height) than at the outer edges (i.e. the exterior height). Using this unique electrode shape, the resulting electrode assembly 601 resembles more the appearance of a baked cinnamon bun (with a tapered top) than the traditional jelly roll (with planar ends that extend perpendicularly from the sides). The taper is laterally transverse to the winding of the overall shape.

Turning now to FIGS. 7A-C, illustrated therein are various forms of electrodes that may be used to create the cinnamon bun shaped electrode assembly in accordance with the invention. Each electrode has a profile shape that is defined by a predetermined length between a first longitudinal end 701 and a second longitudinal end 702. Each electrode likewise has a height defined by an upper side 703 and a lower side 704. While the plan view of FIGS. 7A-C is two dimensional, the actual electrodes also have a finite width defined by a first lateral side 705 and a second lateral side 706.

At least one of the upper side 703 and the lower side 604 includes a taper. In FIGS. 7A-C, for the purposes of discussion, the lower side 704 is shown to include the taper. FIG. 7A illustrates a taper that is curvilinear. FIG. 7B illustrates a taper that is angular. FIG. 7C illustrates a taper that is piecewise linear. In each of FIGS. 7A-C, the height between the upper side 703 and the lower side 704 differs from one longitudinal end 701 to the other longitudinal end 702. In the embodiments of FIGS. 7A-C, longitudinal end 702 is shorter than longitudinal end 701. Experimental results have shown that the electrode is most effective when one longitudinal end 702 is at least 2% shorter than the other longitudinal end 701.

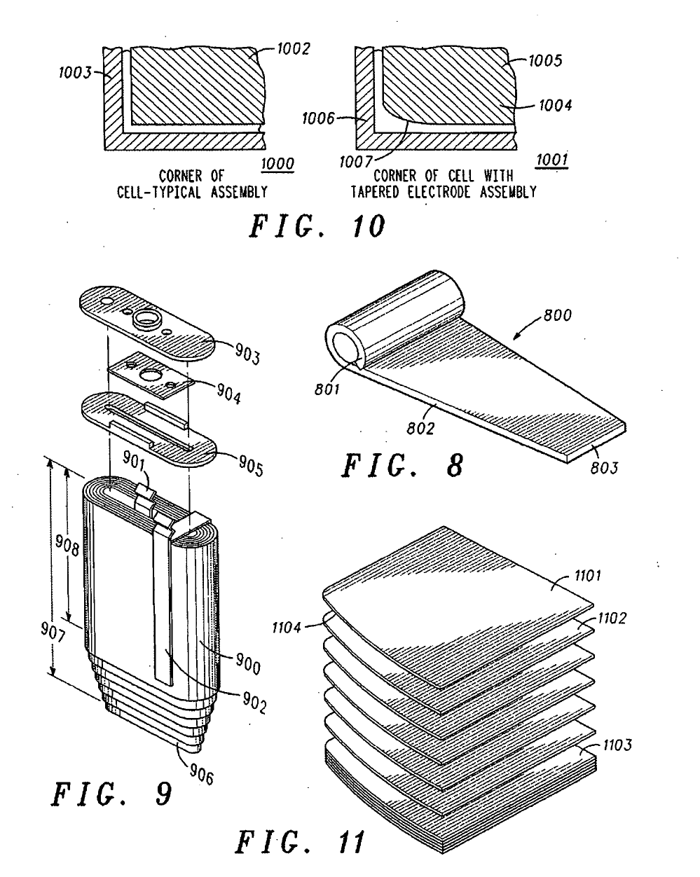

Turning now to FIG. 8, illustrated therein is an electrode 800, such as any of the ones illustrated in FIGS. 7A-C, being rolled so as to form the cinnamon bun shape. Starting at the wide end 801, the electrode 800 is rolled at an appropriate speed, attempting to keep the edge that will become the top of the electrode assembly even, such that a substantially planar end will result. When the roll gets to the narrow end 803, the tapered side 802 causes the exterior height to be shorter than the central height at the wide end 801. The roll is effectively wound in a spiral having a perimeter determined by the length of the profile shape of the electrode 800, the winding beginning at one of the longitudinal ends such that one lateral side of the profile shape substantially contacts the other lateral side of the profile shape in adjacent layers of the spiral.

Referring now to FIG. 9, illustrated therein is a cell assembly in accordance with the invention. A cinnamon bun electrode assembly 900 with cathode 901 and anode 902 is provided. The cinnamon bun 900 will be inserted into a metal can (not shown). The assembly includes a first metal connector 903 that serves as the external cathode and a tab 904 for coupling the first metal connector 903 to the cathode 901. An optional insulator 905 is provided to isolate the first metal connector 903 from the anode 902. Flat, top insulators, at one end of the cinnamon bun 900, are known in the art as recited in U.S. Pat. No. 6,317,335 to Zayatz.

In accordance with the invention, the cinnamon bun electrode assembly 900, which would normally be substantially planar and would contact the can across the bottom of the can, has been tapered on at least one end. The electrode assembly 900 has a central height 907 and an exterior height 908. The central height 907 of the electrode assembly 900 is preferably at least 2% longer than the exterior height 908.

When the electrode assembly 900 is inserted into a housing or can (not shown), the central height will be roughly equivalent to the interior height of the can, neglecting space required for tabs 904, insulators, 905 and other components, including current interrupt devices. The exterior height 908 of the electrode assembly 900 will generally be at least 2% shorter than the effective interior height of the housing.

The electrode assembly 900 of FIG. 9 has a first end 906. The first end 906 has a cross sectional or profile shape that includes a taper. As mentioned in the discussion of FIGS. 7A-C, the taper may be curvilinear, like an exponential or parabolic curve for example. The taper may also be angular or piecewise linear. For cinnamon bun construction, the taper is laterally transverse to a winding of the electrode assembly. When the electrode assembly 900 is inserted into the can, the taper provides at least one void between the first end and a corner of the housing.

Turning now to FIG. 10, illustrated therein is a comparison of cross-sectional views of the prior art cell 1000 and a cell in accordance with the invention 1001. In the prior art cell 1000, the jellyroll 1002 mounts flush against the metal can 1003. However, in the cell in accordance with the invention 1001, the taper 1004 leaves a void 1007 between the cinnamon bun 1005 and the metal can 1006. This void allows the can 1006 to deform, or “crumple”, when dropped on a corner, while the cinnamon bun 1005 remains unharmed. With the taper 1004, test results have shown that zero batteries in 250 failed as a result of the 30 drops to concrete.

Turning now to FIG. 11, illustrated therein is an alternate construction of an electrode assembly in accordance with the invention. In this embodiment, layers of electrode 1101,1102 are stacked to form an electrode assembly 1103. In this stacked method, each layer, e.g. 1101, has some form of taper 1104 or radius on at least one end. This particular taper 1104, which may be curvilinear, angular or piecewise linear, begins at a first lateral side and extends outward from the center of the electrode. The taper 1104 then reaches a predetermined length somewhere near the middle of one end of the electrode, and then tapers back to the opposite lateral side. These layers 1101, 1102 may then be adhered together with a binder, gel, polymer or electrolyte to form a stacked electrode assembly 1103.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. For example, while one preferred embodiment of an electrode assembly illustrated herein had a taper on one end of the assembly, the electrode assembly may have tapers at both ends or on the sides.

What is claimed is:

1. A battery cell, the cell comprising:
a. a housing;
b. an electrode assembly, the electrode assembly comprising an anode and cathode, wherein the electrode assembly has a central height and an exterior height;
wherein the central height of the electrode assembly is at least 2% longer than the exterior height.

2. The cell of claim 1, wherein the housing has an interior height, and the exterior height of the electrode assembly is at least 2% shorter than the interior height of the housing.

3. The cell of claim 1, wherein the electrode assembly comprises a first end, wherein the first end has a profile shape comprising a taper.

4. The cell of claim 3, wherein the taper is laterally transverse to a winding of the electrode assembly.

5. The cell of claim 3, wherein the taper is curvilinear.

6. The cell of claim 3, wherein the taper is angular.

7. The cell of claim 3, wherein the taper is piecewise linear.

8. The cell of claim 3, wherein the insertion of the electrode assembly provides at least one void between the first end and a corner of the housing.

9. The cell of claim 3, wherein the electrode assembly comprises a second end, wherein the second end has a profile shape comprising a taper.

10. The cell of claim 3, wherein the electrode assembly is constructed by a method selected from the group consisting of stacking and rolling.

11. An electronic device, the device comprising the cell of claim 3.

12. The device of claim 9, wherein the device is selected from the group consisting of handheld games, compact disc players, radios, personal data assistants, pagers and phones.

13. A form for an electrode assembly, comprising:
a. a profile shape defined by a predetermined length between a first longitudinal end and a second longitudinal end, and a width between a first lateral side and a second lateral side, and a height between an upper side and a lower side:
b. the height between an upper side and a lower side at one longitudinal end of the profile differing from the height at the other longitudinal end.

14. The form of claim 13, wherein the profile shape is wound in a spiral having a perimeter determined by the length of the profile shape, the winding beginning at one of the longitudinal ends such that one lateral side of the profile shape substantially contacts the other lateral side of the profile shape in adjacent layers of the spiral.

15. The form of claim 14, wherein at least one of the upper side and the lower side of the wound profile shape includes a taper.

16. The form of claim 14 wherein at least one of the upper side and the lower side of the wound profile shape forms a substantially planar surface.

17. The form of claim 15 in which the taper extends from a beginning high longitudinal end to a low longitudinal end.

18. The form of claim 17 wherein the taper is laterally transverse to the winding of the shape.

19. The form of claim 17 wherein the taper is angular.

20. The form of claim 17 wherein the taper is curvilinear.
